(19) United States
(12) Patent Application Publication
(10) Pub. No.: US 2002/0170670 A1
(43) Pub. Date: Nov. 21, 2002

(54) System for dispensing and positioning a coupon strip on a film tube

(76) Inventor: Peter Anh Nguyen, Moore, OK (US)

Correspondence Address: Vlaumedia LLC, Attn: Dean Marrikis, 222 Sepulveda Blvd., Suite 1750, El Segundo, CA, 90245, US

(21) Appl. No.: 09/818,273

(22) Filed: Mar. 27, 2001

(51) Int. Cl. C09J 1/00

(52) U.S. Cl. 156/324; 156/247; 156/538

(57) ABSTRACT

A system for dispensing and positioning a strip of coupons from a roll to a web of film, wherein the web of film and strip are subsequently formed into a promotional item, an item of packaging or a bag having a coupon strip mounted thereto. The preferred embodiment of the present invention contemplates a system for mounting the strip of coupons in longitudinal alignment upon a flattened, gusseted film tube for the forming of bags therefrom. A machine for accomplishing this task is shown wherein there is provided a mounting bracket assembly mounted to a horizontal frame or bar on a bag forming machine following gusseting machine in a bag making operation. A roll of coupon strips is mounted to a spindle, which spindle is supported by first and second vertical support members emanating from the support bracket. The spindle is vertically adjustable so that it may be situated in various positions upon the first and second vertical support members. In the preferred embodiment of the present invention, the rotation of the spindle is dampened to prevent overspin via frictional braking mechanism or the like. To prevent the coupon strip from mis-alignment as it is dispensed from the roll as it rotates, a vertically actuated idle pulley is configured to raise to contact the outer periphery of the roll during start-up of the roll. To begin, the end of the coupon strip is positioned where desired on the film tube , and taped in place via adhesive tape. The spindle and coupon roll are likewise aligned with the desired position to provide longitudinal alignment with the film tube or web strip. The start-up idle roller is actuated to contact the roller, and the machine started so that the film tube advances, pulling the coupon strip from the roll, causing same to rotate. After start-up, the idle roller is lowered via the actuator.

### TECHNICAL FIELD OF THE INVENTION

The present invention relates to systems for assembly bags, and in particular to a system for dispensing and positioning a strip of coupons from a roll to a web of film, wherein the web of film and strip are subsequently formed into a promotional item, an item of packaging or a bag having a coupon strip mounted thereto.

The preferred embodiment of the present invention contemplates a system for mounting the strip of coupons in longitudinal alignment upon a flattened, gusseted film tube for the forming of bags therefrom. A machine for accomplishing this task is shown wherein there is provided a mounting bracket assembly mounted to a horizontal frame or bar on a bag forming machine following gusseting machine in a bag making operation. A roll of coupon strips is mounted to a spindle, which spindle is supported by first and second vertical support members emanating from the support bracket. The spindle is vertically adjustable so that it may be situated in various positions upon the first and second vertical support members.

In the preferred embodiment of the present invention, the rotation of the spindle is dampened to prevent overspin via frictional braking mechanism or the like. To prevent the coupon strip from misalignment as it is dispensed from the roll as it rotates, a vertically actuated idle pulley is configured to raise to contact the outer periphery of the roll during start-up of the roll. To begin, the end of the coupon strip is positioned where desired on the film tube , and taped in place via adhesive tape. The spindle and coupon roll are likewise aligned with the desired position to provide longitudinal alignment with the film tube or web strip. The start-up idle roller is actuated to contact the roller, and the machine started so that the film tube advances, pulling the coupon strip from the roll, causing same to rotate. After start-up, the idle roller is lowered via the actuator. With this system, the entire coupon roll will empty with no problems as long as the film tube or web strip advances. When the unit stops, however, the coupon roll must be vertically lowered so that the start-up idle roller contacts the outer periphery of the roll in its actuated, up position, and the above start-up procedure is observed.

### BACKGROUND OF THE INVENTION

The prior art has contemplated systems for providing coupons and coupon strips to a continuous web for the forming of a bag, package or the like having a coupon or strip of coupons mounted thereupon. A common problem with prior art systems is that they were either too expensive to justify, or often required frequent operator adjustment and intervention during operation.

U.S. Pat. No. 6,068,584 illustrates a spool situated at the beginning of the bag gusseting machine, with the spool is aligned with a flattened tube where the coupon strip is to be positioned. The spool is situated about a shaft (54), and is shown as being adjustable along the length of the shaft..

U.S. Pat. No. 5,369,936 issued 1994 teaches an “Apparatus and Method for Securing a Detachable Promotional Banner or Coupon to a Flexible Package” wherein a tensioned reel (45) is utilized to dampen the rotation of the spool (30) to prevent overspin (see FIG. 5).

U.S. Pat. No. 4,425,182 teaches a “Blending tape dispenser” wherein (FIG. 1) a “braking means (50) enables backlash of the tape to be controlled and eliminated”, the tape being applied to a continuous web 32 via a spool having a sidewall situated adjacent to one side of the roll, which may be for maintaining the strip on the roll.

U.S. Pat. No. 4,537,586 teaches a “Method and Apparatus for Appying Coupon Strips to Paper Bags” wherein (see FIG. 4) there is shown the spool having side plates 64 for maintain “the coupon roll in a centered position”, as well as a weighted dampener system comprising a weight 56 and an idle roller 60 which engages the face of the roll. On the other side of the roll, a pneumatic brake mechanism 66 is provided which squeezes the roll against the plate 64 to slow down its rotation and thereby tension coupon strip 32.

U.S. Pat. No. 6,651,499 teaches a “Narrow Film Band Adapter” comprising a frame for holding the roll which is mounted to the horizontal bar of a support frame, and is cited as having some general structural similarities to the present system.

U.S. Pat. No. 5,882,118 illustrates a grocery bag having a coupon strip mounted thereto.

U.S. Pat. No. 5,298,104 is provided as another example of a labeling machine for a continuous web stream.

In summary, the prior art illustrates various systems for mounting coupons or coupon strips to a continuous web, as well as the general premise of a coupon strip mounted to a bag along its length.

### GENERAL SUMMARY DISCUSSION OF THE INVENTION

However, unlike the prior art, the present invention provides a system for dispensing and positioning a strip of coupons from a roll to a position longitudinally aligned with and adjacent to a film tube which is easier and more cost effective to implement, operate, and maintain.

The preferred embodiment of the present invention contemplates a system wherein there is provided a mounting bracket adjustably mounted to a horizontal frame or bar on a bag forming machine following a gusseting machine in a bag making operation. The roll of coupon strips is mounted to a spindle, which spindle is supported by first and second vertical support members emanating from the support bracket. The spindle is vertically adjustable so that it may be situated in various positions upon the first and second vertical support members.

In the preferred embodiment of the present invention, the rotation of the spindle is dampened to prevent overspin via a frictional means such as a rope engaging the spindle, which rope supports a weight. Alternatively, other brake or clutch means could be used to provide adjustable dampening of the spindle.

To prevent mis-alignment of the coupon strip during the start-up process, an idle pulley is provided under the roller which is vertically actuatable via an actuator so that said idle pulley engages the bottom of the coupon roll, urging the outer face of the coupon roll to remain on center during start-up. To begin, the end of the coupon strip is positioned where desired on the film tube and taped in place via adhesive tape. The spindle and coupon roll are likewise aligned with the desired position. The start-up idle roller is actuated to contact the roller, and the machine started so that the film tube advances, pulling the coupon strip form the roll, causing the roll to rotate.

After start-up, the idle pulley is lowered via the actuator. With this system, the entire coupon roll will empty with no problems as long as the system is moving. Whenever the unit stops, however, the above start-up procedure must be observed.

In an alternative embodiment of the present invention, first and second sets of alignment/braking rollers are mounted so as to engage the sidewalls of the roller, so as to both provide a dampening action for the roll, as well as maintaining the strip in alignment on the roll as it is being dispensed. With this system, no other dampening means is necessary, nor is required to utilize the lifting idle roller for startup.

It is therefore an object of the present invention to provide an improved system for dispensing a coupon strip to a continuous web, which may be in the form of a flattened film tube.

It is another object of the present invention to provide a method of dispensing a coupon strip from a coupon roll to a continuous web, including the steps of providing a spool dispensing a tensioned coupon strip, contacting the outer periphery of said coupon strip with an idle roller, pulling said coupon strip to rotate said coupon roll, lowering said idle roller, and allowing said coupon roll to rotate as said coupon strip is pulled therefrom.

It is still another object of the present invention to provide an apparatus for tensioning and aligning a film roll as film is being dispensed therefrom, comprising first and second dampened idle rollers in contact with first and second side walls of said film roll, respectively.

It is another object of the present invention to provide a system for dispensing a coupon to a continuous web that is easier to operate and maintain, and more cost effective to purchase and install than prior art systems, providing a consistent and reliable coupon strip dispenser.

Lastly, it is an object to provide a system for dispensing a coupon strip to a continuous, flattened tube of plastic film, which system mounts to and is adaptable to operate with a number of different bag forming machines.

### BRIEF DESCRIPTION OF DRAWINGS

For a further understanding of the nature and objects of the present invention, reference should be had to the following detailed description, taken in conjunction with the accompanying drawings, in which like parts are given like reference numerals, and wherein:

FIG. 1A is an isometric view of an exemplary, prior-art bag having a coupon strip mounted thereto.

FIG. 1B is a cut-away, close-up view of the bag of FIG. 1A.

FIG. 2A is an isometric view of the preferred embodiment of the apparatus of the present invention, illustrating the coupon roll mounted to a dampened spindle, which spindle is vertically supported above a flattened film tube in a bag forming machine, and a coupon strip from the coupon roll being mounted to said film web.

FIG. 2B is a side, close-up view of a vertically actuated idle roller, illustrating one end of the roller and the movement of the actuator.

FIG. 2C is a side view of the system of FIG. 2A, illustrating the movement of the flattened film tube, the movement of the coupon roll and dispensed coupon strip relative to said film tube, and the positioning of the actuatable idle roller on start-up.

FIG. 2D is a side view of the invention of FIG. 2C, illustrating the actuatable idle roller in its lowered position after start-up.

FIG. 3A is an isometric, close-up view of an alternative embodiment of the present invention, illustrating a idle roller system which is mounted to opposing sides of the coupon roll, so as to dampen the rotation of said coupon roll about the spindle and tension the coupon strip issuing therefrom, as well as maintaining alignment of the coupon strip as it is dispensed from the roll.

FIG. 3B is a front view of the invention of FIG. 3A.

FIG. 3C is a side view of the invention of FIG. 3A, illustrating the adjustability of the system along the side wall of the coupon roll.

### DETAILED DISCUSSION OF THE INVENTION

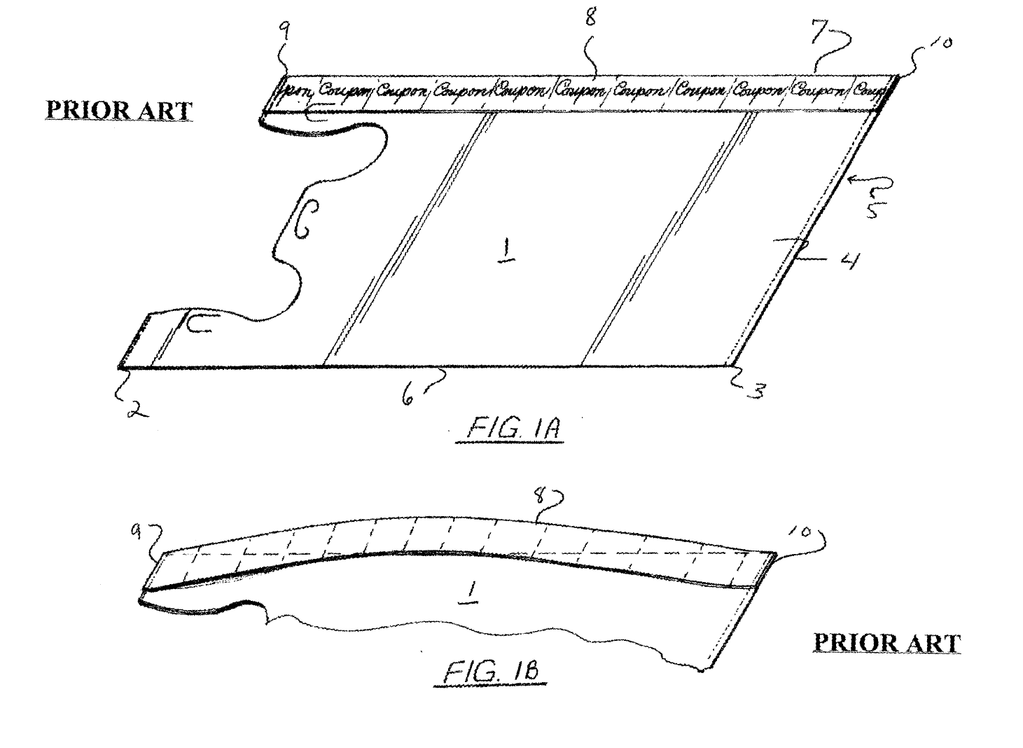

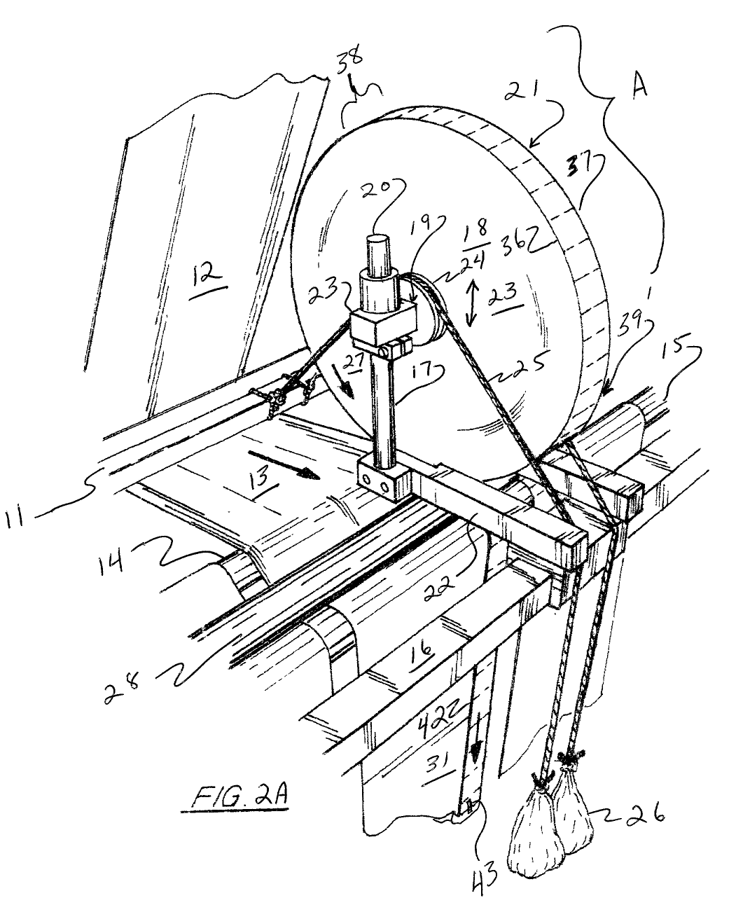

The preferred embodiment of the present invention is configured to apply a coupon strip to an continuous web of film, preferably flattened film tubing, which flattened film tubing an coupon strip are utilized to form a bag such as that shown in FIGS. 1A and 1B, wherein a coupon strip 8 having first 9 and second 10 ends is affixed to a first side 4 (or second side 5) of a bag 1 at its first 2 and second 3 ends, respectively, said coupon strip generally aligned and situated near the first 6 or second 7 edges of said bag.

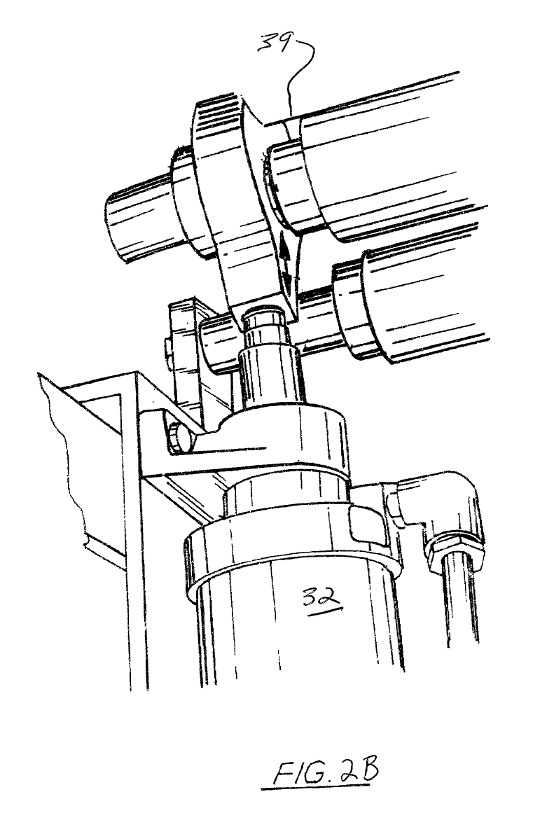

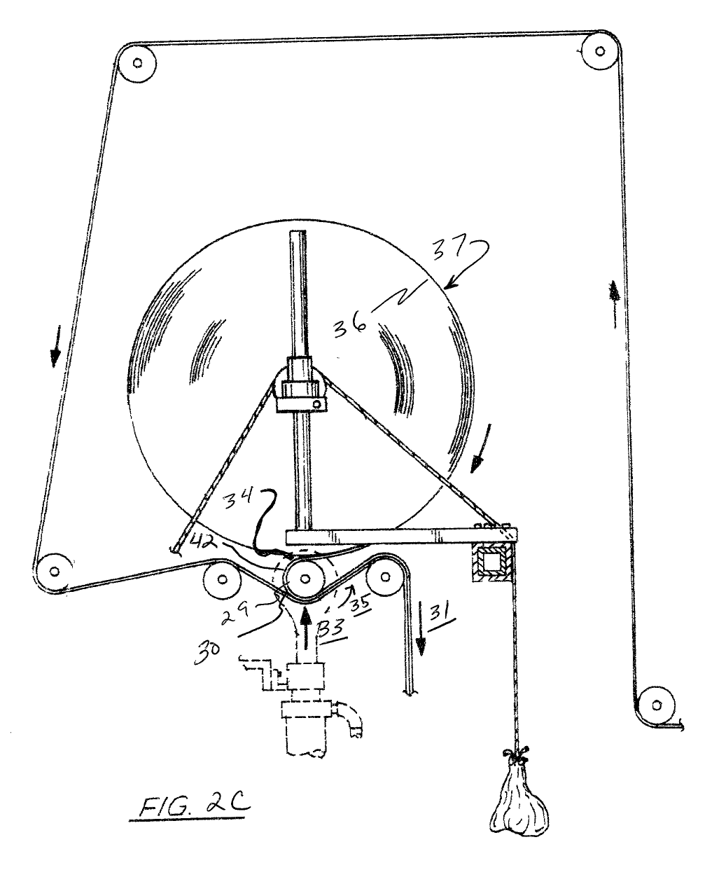

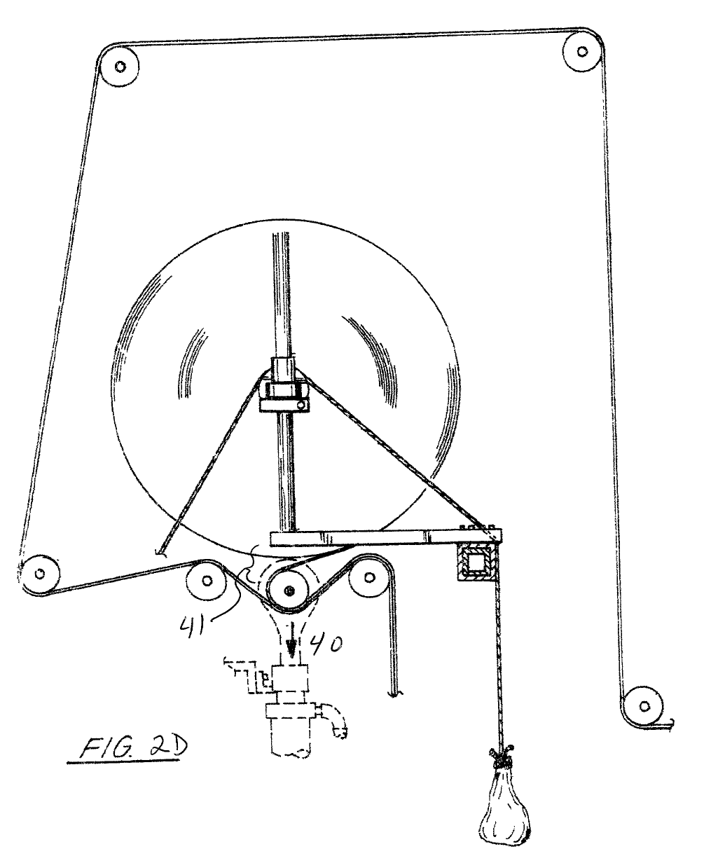

Continuing with FIGS. 2A, 2B, 2C, and 2D, a bag making machine 11 such as, for example, a LEMO brand INTERNET model 1100CC receives a flattened film tube 12 advancing 13 at a rate of up to 136 meters/minute, the film generally advancing from a gussetting station. The apparatus A of the preferred embodiment of the present invention is configured to mount in the vicinity of the film tube 12 prior to its being formed into a bag, the apparatus as shown mounted upon a bar 16 forming part of the frame of the bag making machine 11.

As shown, the flattened film tube 12 progresses from the gussetting machine to the bag making machine 11, advancing 13 in operation over idle rollers 14, 15 as it progresses to the bag forming area of the machine. The coupon strip dispensing apparatus 17 is configured to support a roll 18 of coupons via a spindle 19, the spindle supported at its opposing ends via first 20 and second 21 vertical support members, which spindle is adjustably mounted to said vertical support members 20, 21 via mounts 23, 23′ in vertically adjustable fashion. The vertical support members 20, 21 are in turn supported above the rollers 14, 15 and progressing film tube 12 via horizontal support members 22, which are mounted to bar 16. As shown, the supported coupon roll is situated over and aligned with the film tube 12 to which the coupon strip is to be applied.

The spindle 19 supporting the coupon roll allows the coupon roll to rotate 27 in operation, yet provides a dampener 24 to maintain tension on the coupon strip being dispensed, as well as preventing overspin of the coupon roll 18 should the film tube cease advancing. While the spindle could be dampened in a variety of known means, such as a friction brake system, or clutching system, the exemplary dampener 24 illustrated shows a rope 25 having a weight 26 thereupon engaging the spindle so as to frictionally dampen the spindle as it rotates.

Situated between and aligned with idle rollers 14, 15 is a roller 28, having first 39, and second 39′ ends, which roller is situated below coupon roll 18. As shown in FIGS. 2A, 2b, and 2C, the roller 28 can be upwardly advanced 33 via actuator 32 at its opposing ends 39, 39′ so that the outer surface of the roller 28 communicates with the outer diameter 34 of the roll, to facilitate start-up of the dispensing of the coupon strip 42 from the roll.

In use, the coupon roll is installed upon the spindle 19 and the roll aligned with the film tube or other continuous web which is to receive the coupon strip, with the roller 28 situated in the vicinity of the coupon roll. The coupon strip is then fed about 29 and under the roller 28, and the end of the strip is then affixed, via adhesive tape or the like, to the film tube to which it is to be joined. The roller 28 is then upwardly advanced 33 so that said roller contacts the outer diameter of the coupon roll. The flattened film tube 12 or web strip is then advanced, and because the film tube engages roller 28, and because the coupon strip 42 is taped 43 to said film tube, the idle roller (which rotates 35 due to contact with the advancing film) and tensioned coupon strip advance 31 urge coupon roll to rotate 27. During start-up of the rotation of the roll, it has been found that this is the point most often when the coupon strip forming the outer diameter of the roll comes out of alignment 38 and begins to slip from the edges of the roll, which will cause the tape to break. However, it has been found that having the roller 28 contacting the outer diameter of the roll during start-up keeps the outermost strip forming the outer diameter in alignment 38, and once the coupon roll begins to rotate, the idle roller can be downwardly advanced 40 (FIG. 2D), spacing 41 the roller from the coupon roll, and allowing the coupon strip 42 to advance in the desired position in contact with the flattened film tube 12.

If the machine is stopped and the flattened film tube 12 or web no longer advances, then the roller 28 must then be raised via the actuators, and the roll must be lowered via the vertically adjustable spindle mounts 23, 23′ so that the outer diameter of the coupon roll contacts the raised roller. Once the machine is initiated and the film tube advances to start rotation of the roll, the roller 28 may again be lowered. When a new roll replaces the old roll, the process is repeated.

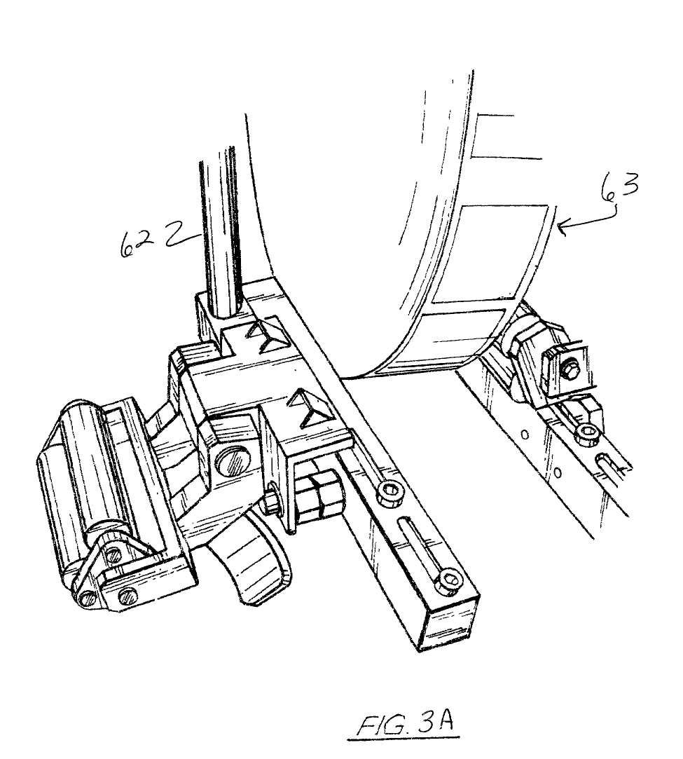

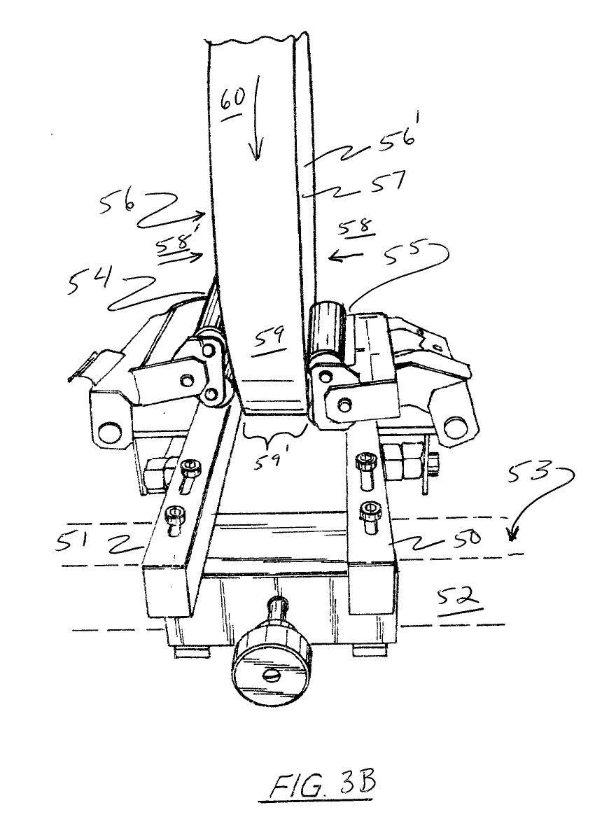

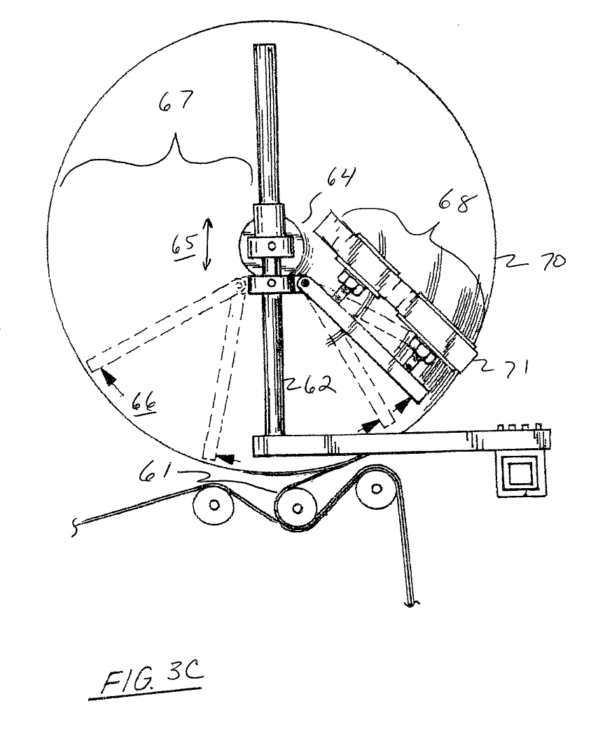

FIGS. 3A-3C illustrate an alternative embodiment 50 of the present invention, wherein there is provided a device 51 which positions first 54 and second 55 idle rollers engaging opposing side walls 56, 56′ of a coupon roll 57, respectively, dampening the rotation of the roll about the spindle via pressure 58 against the opposing sides of the roll, while maintaining alignment 59′ of the coupon strip 59 forming the outer diameter of the roll as it rotates 60 to dispense 61 the coupon strip 69 therefrom.

Like the preferred embodiment, the coupon roll 57 is supported via first 62 and second 63 support members, and a vertically adjustable 65 spindle 64 rotatably supports the coupon roll.

As shown, ideally the roller(s) on each side of the coupon roll can either comprise more than one roller in a linear, series mount, or can comprise a single roller having a length 68 about equal or greater than the radius 67 of the coupon roll, and the roller may be adjustable angularly 66 if desired (as shown in FIG. 3C). Ideally, the distal end 71 of each opposing roller would extend at least to the outer edge 70 of the roll to insure alignment of the coupon strip about the roll. Moreover, there may be provided two rolls on each side of the roller as shown in FIG. 3B.

In use, the alternative system would not require the lower roller to be actuatable, and start-up of the roller would simply require positioning the roller above the film, threading the coupon strip about the lower roller to contact the film, adhering the end of the coupon strip to the film (via, for example, adhesive tape) where it is desired that the coupon be situated on the film, lining up the coupon strip and roller with the film, and advancing the film. If the film were to stop, the dampened roll would cease to rotate due to the dampening action of the idle rollers 54, 55. To restart, one would merely advance the film. If the coupon roll was dispensed a substantial degree, for example, more than one-half, the coupon roll might have to be lowered via lowering the spindle on the support members 62, 63, to facilitate more efficient rotation of the roller via the coupon strip pulling on same from the lower roller.

In this invention, when it is described that the coupon strip is positioned upon a flattened film tube, it is to be understood that the present invention may be utilized to position said strip upon any advancing flexible sheet or web of material, and said coupon strip can comprise any strip of thin, flexible material provided in a roll or spool.

The invention embodiments herein described are done so in detail for exemplary purposes only, and may be subject to many different variations in design, structure, application and operation methodology. Thus, the detailed disclosures therein should be interpreted in an illustrative, exemplary manner, and not in a limited sense.

### ELEMENTS of the Invention

Date: Friday, Mar. 23, 2001 04:20pm

Client: NGUYP01/01

Title: System for dispensing and positioning a coupon strip on a film tube.

| Element | Description |
|---|---|
| A | apparatus |
| 1 | bag |
| 2 | first |
| 3 | second ends |
| 4 | first |
| 5 | second sides |
| 6 | first |
| 7 | second edges |
| 8 | coupon strip |
| 9 | first |
| 10 | second ends |
| 11 | bag making machine |
| 12 | flattened film tube |
| 13 | advancing |
| 14 | idle roller |
| 15 | idle roller |
| 16 | bar |
| 17 | coupon strip dispensing apparatus |
| 18 | coupon roll |
| 19 | spindle |
| 20 | first |
| 21 | second vertical supports |
| 22 | horizontal support member |
| 23, 23′ | spindle mount, vertically adjustable |
| 24 | damper mechanism |
| 25 | rope |
| 26 | weight |
| 27 | rotation |
| 28 | central roller |
| 29 | about the roller |
| 30 | laid upon flattened film |
| 31 | advances.. with tube |
| 32 | actuator |
| 33 | upwardly advances |
| 34 | contacting outer face of roll |
| 35 | rotating |
| 36 | side wall |
| 37 | side wall of roler |
| 38 | alignment |
| 39 | first, second ends of central roller |
| 40 | down wardly advances |
| 41 | spaced from roller |
| 42 | coupon strip |
| 43 | tape 3 |
| 44 | |
| 45 | |
| 46 | |
| 47 | |
| 48 | |
| 49 | |
| 50 | alternative embodiment |
| 51 | device |
| 52 | bar |
| 53 | bag forming machine |
| 54 | first |
| 55 | second idle rollers |
| 56,′ | engage opposing side walls |
| 57 | coupon roll |
| 58 | dampend via pressure against sides or otherwise |
| 59,′ | maintaining coupon strip forming outer face of roll in alignment |
| 60 | rotates |
| 61 | dispensed |
| 62 | support member |
| 63 | support member |
| 64 | spindle |
| 65 | adjustable |
| 66 | adjustable angularly |
| 67 | radius of roll |
| 68 | length of roller |
| 69 | coupon strip |
| 70 | outer edge |
| 71 | distal end |

What is claimed is:

1. An apparatus for dispensing a strip of material from a roll having an outer diameter, and placing the strip upon an advancing sheet, comprising:
a spindle for receiving and rotationally supporting the roll, said spindle further comprising means for dampening the rotation of said roll;
an idle roller having first and second ends and an outer surface, said idle roller situated adjacent to said advancing sheet, said idle roller positioned under said roll so as to receive said strip about a portion of said outer surface of said idle roller, said idle roller further comprising actuation means to vertically actuate said idle roller in a first direction, such that said outer surface of said idle roller contacts said outer diameter of said roll to facilitate rotation of said roll, said actuation means further to vertically actuate said idle roller in a second direction, such that said outer surface of said idle roller is spaced from the outer diameter of the roll, so as to allow the continued dispensing of strip material from the roll.

2. The apparatus of claim 1, wherein said means for dampening the rotation of said roll comprises a frictional brake engaging said spindle.

3. The apparatus of claim 2, wherein said actuation means comprises first and second actuators contacting said first and second ends of said idle roller, respectively.

4. The apparatus of claim 3, wherein said spindle further comprises first and second ends adjustably engaging first and second vertical support members.

5. An apparatus for supporting a roll of material forming a strip, the roll having first and second sides, a radius, and an outer diameter, the apparatus further configured for placing the strip upon an advancing sheet, the apparatus comprising:
a spindle for receiving and rotationally supporting the roll;
first and second idle rollers having a length and an outer surface, said first and second idle roller removably engaging said first and second sides of said roll, respectively, said length of said first and second rollers a portion of said radius of said roll, respectively, so as to dampen the rotation of the roll upon said spindle, while maintaining said strip in alignment on said roll; and
an idle roller having first and second ends and an outer surface, said idle roller situated adjacent to said advancing sheet, said idle roller positioned in spaced relationship under said roll so as to receive said strip about a portion of said outer surface of said idle roller.

6. The method of dispensing a strip from a roll to an advancing sheet, comprising the steps of:
a. rotatably supporting said roll in the vicinity of said advancing sheet;
b. taping said strip to said roll;
c. contacting a rollerwith the outer diameter of said roll, providing a contacting roller;
d. advancing said sheet, advancing said strip, so as to cause said roll to rotate;
e. spacing said contacting roller from said outer diameter roll so that said contacting roller no longer contacts said roll; while;
f. dampening the rotation of said roll;
g. allowing said strip to advance from said roll upon said advancing sheet.

7. The method of claim 6, wherein after step “g.” there is further provided the steps of:
h. of stopping the advancement of said sheet;
I. lifting said roller;
j. downwardly adjusting said spindle until the outer diameter of the roll contacts the outer surface of said roller;
k. Repeating steps e.-g..

8. The method of dispensing a strip from a roll to an advancing sheet, comprising the steps of:
a. rotatably supporting said roll in the vicinity of said advancing sheet;
b. taping said strip to said roll;
c. contacting a first and second rollers with the first and second sides of said roll such that the length of each of said first and second rollers engages a radius of said first and second sides of said roll, respectively;
d. advancing said sheet, advancing said strip, so as to cause said roll to rotate;
f. allowing said engagement of said first and second rollers with said first and second sides of said roll to dampen the rotation of said roll; while
g. allowing said engagement of said first and second roller with said first and second sides of said roll to maintain said strip on the outer diameter of said roll in an aligned fashion.
